(19) United States
(12) Patent Application Publication
(10) Pub. No.: US 2025/0290817 A1
(43) Pub. Date: Sep. 18, 2025

(54) METHOD OF IDENTIFYING THE DYNAMIC BEHAVIOR OF A NON-RIGID OBJECT

(71) Applicant: PHILOPTERE, Saint Nom la Breteche (FR)

(72) Inventor: Philippe PERRIER, Saint Nom la Breteche (FR)

(21) Appl. No.: 19/080,021

(22) Filed: Mar. 14, 2025

(30) Foreign Application Priority Data
Mar. 14, 2024 (FR) FR2402527

(51) Int. Cl. G01M 1/22; G06F 17/14

(52) U.S. Cl. CPC G01M 1/22; G06F 17/142

(57) ABSTRACT

A method of identifying the dynamic behavior of a non-rigid object is proposed, the object being firmly fixed to a platform that can be set in motion by a drive device The method comprises activating the drive device so as to give the object a predefined periodic movement at a frequency referred to as “cycle frequency.” The periodic movement is a combination of at least two geometrically independent periodic elementary movements. The method comprises recording, during activation, the variation in at least one variable representative of a dynamic behavior, referred to as “dynamic variable”, and calculating, for each of the cycle frequencies, components referred to as “elementary components”, of a Fourier transform of the variation of the at least one dynamic variable for each elementary frequency. A dynamic behavior of the object is determined as a function of the variation in the elementary components.

### TECHNICAL FIELD

The present document refers to the methods and devices for determining at least one characteristic of the dynamic behavior of an object likely to have at least one resonance mode, such as for example an object having at least one flexible, elastic, or liquid part.

### PRIOR ART

When a rigid object is subjected to linear or angular accelerations, it counters with response forces that are entirely represented by inertial characteristics: mass, center of gravity coordinates, moments and products of inertia. But if an object is not entirely rigid and comprises, for example, flexible parts, or parts containing liquid, it presents a particular behavior with resonance modes that correspond to the maximum displacement of the non-rigid parts compared to the rest of the object.

Resonance is a physical phenomenon that is produced when the frequency of a periodic movement applied to a system is equal to the natural resonance frequency of the system. The natural resonance frequency of a system is the frequency at which the system vibrates most easily and accumulates the most energy when it is excited by the periodic movement. A resonance mode is characterized by a frequency known as the resonance frequency, the parameters of the movement that generates the resonance, and the amplitude of the response of the object. The amplitude of the response of the object may be characterized by different physical variables associated with the resonance mode such as, for example, the forces that must be applied to the object or to a part of the object, the stresses in certain parts, the pressures on the walls of a reservoir, the relative displacement of certain parts. Each physical system possesses one or more natural resonance frequencies associated with its physical and geometrical properties. An object is considered to be rigid if it does not present any resonance frequency under the conditions of its operational use. Resonance may have undesirable effects; it may, for example, cause structural damage or failures, such as in the case of liquid contained in a reservoir.

As a consequence, the response forces of an object presenting a non-rigid part may be very different from those of a rigid object and cannot be represented by only the inertial characteristics cited above. If the non-rigid parts have a significant mass compared to that of the complete object, their behavior may strongly modify that of the complete object or vehicle to which it belongs. The resonance modes may damage certain parts beyond a certain stress amplitude.

In the particular case of a partially-filled reservoir subjected to movements, the liquid is itself driven in complex movements, combinations of free surface waves generated by the movements of the reservoir. These waves give rise to response forces on the walls of the reservoir. They may have an effect on the behavior of the moving vehicle to which the reservoir is attached, for example any type of land, aerial or sea vehicle. This problem is thus critical for reservoirs containing liquid propellants of space launchers. For example, the loss of a Falcon 1 satellite launcher due to uncontrolled sloshing of the propellant in a reservoir may be cited. They may also be concentrated on a point of the walls, generating very significant local pressures likely to damage these walls. The forces are highly dependent on the fill level of the reservoir, the type of movements that it is subjected to, and their frequency. Such movements of liquid are generally designated by the term “sloshing.” Identifying the characteristics of the sloshing as a function of reservoir movements is thus important. The main characteristics to be identified are the resonance modes that lead to the greatest forces on the reservoir and are likely to promote focalizations on certain points of the walls.

This identification is generally done by placing the object or a reduced-scale model on a platform and applying to it generic movements identified by other means as being representative of the movements to which it may be subjected in its operational use. Force sensors placed on the platform, on the object to be measured, or on certain parts of the object make it possible to identify the response to the stresses and to detect the resonance modes. In the case of a reservoir, it may have local pressure sensors, making it possible to quantify the response of the liquid to stresses. These generic movements may be, for example, roll, pitch and yaw oscillations applied successively with different amplitudes and different frequencies. Descriptions of these methods applied to liquid reservoirs may be found in KR101721498B1, CN105806578A, KR101259146B1, WO2020225353A1.

The “Sloshel” project is an industry project shared by several companies, which has the object of collecting data from large-scale sloshing experiments; the calculation method used in the “Sloshel” project has the main disadvantage of requiring a large number of tests in order to explore the different combinations of movements and frequencies. For a reservoir, the resonance modes for different fill levels must be sought. The identification of movements to be applied is a preliminary phase that may be time-consuming and costly.

In addition, an inertial balance device is known such as that disclosed in FR1858787, making it possible to apply to an object a predefined periodic movement composed of the superposition of elementary movements at harmonic frequencies of the frequency of the complete cycle. The objective of this device is to measure the inertial characteristics of a rigid object, but the method described in FR1858787 does not allow determining the characteristics of an object presenting a flexible or liquid part.

### SUMMARY

The present disclosure improves the situation.

A method of identifying the behavior of a non-rigid object is proposed, the object being firmly fixed to a platform that can be set into motion by a drive device, the method comprising: activating the drive device so as to impart to the object a predefined periodic movement at a frequency referred to as a “cycle frequency,” the periodic movement being a combination of at least two geometrically-independent periodic elementary movements, the at least two elementary movements each having a frequency, referred to as “elementary frequency,” which is an integer multiple of the cycle frequency, at most two of the at least two elementary movements being of the same elementary frequency; if the periodic movement comprises two elementary movements of a same elementary frequency then they are of different phases, preferentially in phase quadrature, the activation being done during at least one period of the periodic movement; recording during the activation the variation of at least one variable representative of a dynamic behavior, referred to as a “dynamic variable,” collected by at least one sensor disposed on at least one of the platform and the object; repeating the activation of the drive device and recording of the variation of the at least one dynamic variable at various cycle frequencies at each time during at least one period of the periodic movement, the various cycle frequencies being within a predefined frequency range; calculating, by a calculating unit, for each of the cycle frequencies within the predefined frequency range, the components of a Fourier transform of the variation of the at least one dynamic variable for each elementary frequency, the components, referred to as “elementary components,” including an intensity elementary component and a phase elementary component; and determining, according to the variation of the elementary components, a dynamic behavior of the object.

The features stated in the following paragraphs may, optionally, be implemented independently from each other or in combination with each other:
the at least two elementary movements have two different elementary frequencies, preferentially in ratios of 2 and 3 or 3 and 4 in relation to the cycle frequency, or the at least two elementary movements have three different elementary frequencies, preferentially in ratios of 4, 5 and 6 in relation to the cycle frequency.
determining the dynamic behavior of the object comprises observing that the variation in elementary components is not a linear function of the square of the cycle frequency.
the the at least one variable representative of a dynamic behavior is representative of a condition of resonance of the object, and this variable is referred to as “resonance variable,” and determining the dynamic behavior of the object comprises identifying at least one resonance frequency for each of the at least two elementary movements on the basis of variations in accordance with the elementary frequencies of the elementary components of each of the at least two elementary movements.
identifying at least one resonance frequency for each of the at least two elementary movements, including identifying an extremum of the intensity elementary component for each of the at least two elementary movements.
the method furthermore comprises determining an amplitude of the at least one resonance variable for the at least one resonance frequency, this determination being made based on variations in the at least one resonance variable in accordance with the elementary frequencies of the elementary components of each of the at least two elementary movements.
the amplitude of the at least one resonance variable is the amplitude of the extremum of the intensity elementary component of the at least one resonance variable at the at least one identified resonance frequency.
the method furthermore comprises identifying, for each of the identified resonance frequencies, of a resonance mode of the at least one resonance variable, the resonance mode furthermore being characterized by an amplitude of the intensity elementary component at the resonance frequency under consideration, and a direction associated with the elementary movement for the resonance frequency under consideration.
if one of the identified resonance frequencies for each of the at least two elementary movements is identical for several elementary movements, then the resonance mode is characterized by the combination of these elementary movements.
the object is a reservoir containing a liquid, and determining the dynamic behavior comprises a step of measuring the dynamic variables with the empty reservoir, and determining, by subtracting the elementary components, only the effects of the liquid.
the at least one sensor comprises at least one of a plurality of force sensors, accelerometers disposed on the parts of the object that are subject to resonance, pressure sensors disposed on the rigid parts of the object, and strain gauges disposed on the flexible parts of the object.
the at least one resonance variable collected by the at least one sensor is recorded at a rate higher than at least 4 times a highest elementary frequency, and preferably higher than 10 times.
in which repeating the activation is done by increasing cycle frequencies in the predefined frequency range.

### Advantages

One advantage of this method is that it is not necessary to successively apply different elementary movements at different frequencies in order to identify the resonance modes. The periodic movement applied to the object makes it possible to stress all the elementary movements in a single frequency ramping. The consequence is time savings for taking measurements.

Another advantage of the method is that it makes it possible to use a moving means in which the movement is entirely predefined, possibly including by mechanical connections, such as for example the one described in FR1752729. Such a means will enable reproducibility of the movements and simplicity of use.

The present method stresses, by the combination of elementary movements, all axes of movement of the solid. As a consequence, it is not necessary to identify beforehand the possible movements of the solid in its operational context.

By making it possible to identify systematically all the resonance modes and their frequencies, the method allows finding the different combinations of frequency modes in which the temporal combination of the extremums is potentially more harmful.

### BRIEF DESCRIPTION OF THE DRAWINGS

Other features, details and advantages will appear upon reading the detailed description below, and analyzing the attached drawings, in which:

FIG. 1 shows a flow chart of a method to identify the dynamic behavior of a non-rigid object according to one embodiment.

FIG. 2 shows a drive device according to an embodiment, the device being used for the implementation of the method of FIG. 1.

FIG. 3 shows an example of a displacement curve of an object set into motion according to the method of FIG. 1.

FIG. 4 shows an example of measurements captured by a sensor, of the displacement of a non-rigid part of an object set into motion according to the method of FIG. 1.

FIG. 5 shows an example of variations in elementary components as a function of the cycle frequency of the movement imposed on the object according to the method of FIG. 1.

FIG. 6 shows an example of variations in elementary components as a function of the elementary frequencies of the movement imposed on the object according to the method of FIG. 1.

### DESCRIPTION OF EMBODIMENTS

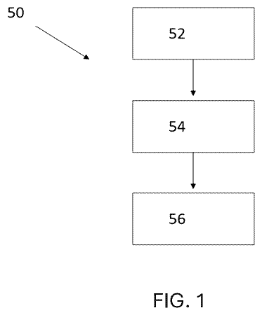

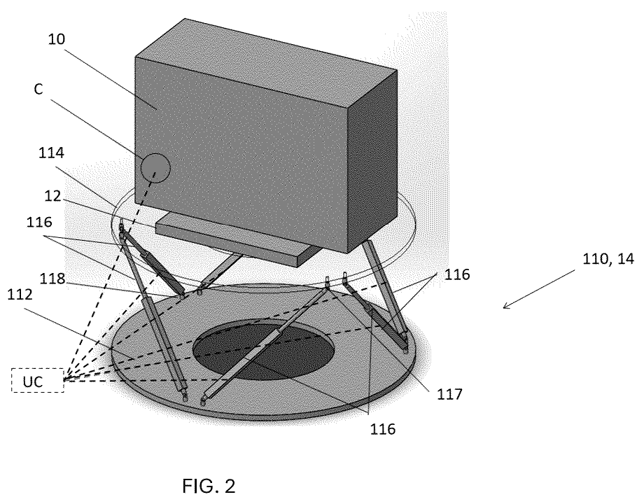

Reference is now made to FIG. 1, which illustrates a method 50. Method 50 described in the present document relates to the experimental identification of the dynamic behavior of an object 10 (shown in FIG. 2), particularly its resonance modes, in a predefined frequency range, without prior knowledge of the movements that may excite them.

Method 50 is applied to a non-rigid object, i.e., an object likely to exhibit resonant behavior. For example, object 10 is partially or entirely flexible, elastic, or presents an articulation. Object 10 may, according to an embodiment, be a rigid reservoir containing a liquid.

To identify the dynamic behavior of object 10, method 50 uses a platform 12 subjected to a predefined periodic movement by means of a drive device 14. According to an embodiment, drive device 14 is a hexapod positioning head. An example of a hexapod positioning head (also known as a Stewart platform) is particularly described in FR1752729.

According to an example, and as illustrated in FIG. 2, an example of a hexapod positioning head 110 includes a base 112, a plate 114 to receive the object 10, and six supports 116 connecting the base 112 to the plate 114. Supports 116 are, in this embodiment, connecting rods. Connecting rods 116 have their upper ends 117 connected to the plate 114 and their lower ends 118 connected to the base 112. Lower ends 118 of at least three connecting rods 116, referred to as controlled supports, are set into motion in order to move plate 114. The supports are controlled by a central processing unit UC. In another embodiment, the supports may be mechanically connected to each other by toothed gears.

The drive device 14 makes it possible to, in particular, impart to object 10 a predefined periodic movement at a frequency referred to as as the “cycle frequency.” The periodic movement enables, in one cycle, object 10 to be moved in several directions. Thus, the periodic movement is a combination of two or more elementary movements. The elementary movements are periodically and geometrically independent (in other words if and only if the vectors describing the movements are independent, it is referred to as “algebraically independent,” i.e., none is a linear combination of the others). Each elementary movement has a frequency, referred to as “elementary frequency,” which is an integer multiple of the cycle frequency (i.e. harmonic). The periodic movement may comprise up to 6 elementary movements representing the 3 rotational movements and the 3 translational movements of any displacement of an object.

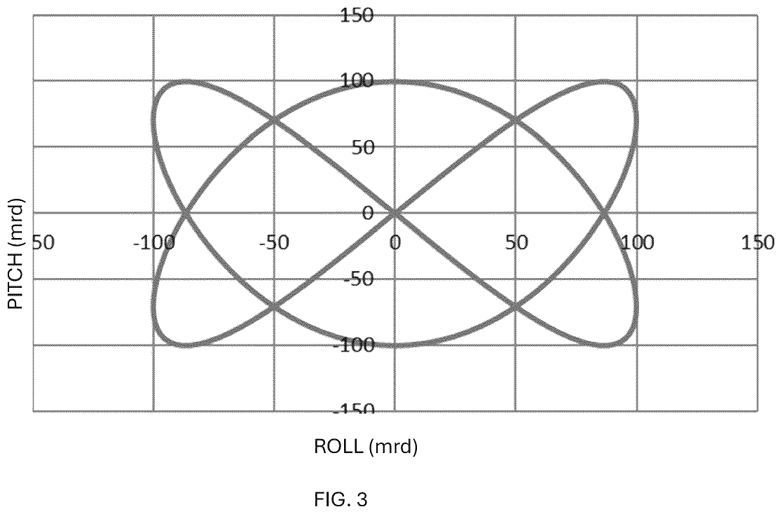

Each elementary movement is characterized by: an amplitude vector that comprises 6 components (Tx, Ty, Tz, Rx, Ry, Rz) where Tx, Ty, Tz are translations in the reference coordinate system, and Rx, Ry, Rz are roll, pitch and yaw rotations in relation to an axis passing through the origin of the reference mark; the elementary frequency; and a possible phase shift in relation to an origin of the cycle (chosen arbitrarily). An example of periodic movement is illustrated in FIG. 3. It is composed of two elementary rotational movements: pitch and roll.

Two at most of the elementary movements of the periodic movement are of the same elementary frequency. If two elementary movements have the same frequency, their phases are then chosen to be different from each other, preferably in quadrature (90° phase shift). This is the case, for example, if one of the movements is sine and the other is cosine. In the case where there are only two different frequencies of the elementary movements, one may preferably choose them to have ratios 2 and 3 or 3 and 4 in relation to the cycle frequency. In the case where there are 3 different frequencies of the elementary movements, one may preferably choose them to have ratios 4, 5 and 6 in relation to the cycle frequency.

For a periodic movement at cycle frequency f, an example of such a combination of 6 elementary movements may be given as follows: a roll movement defined by Rx. sin (4.f.2.π.t), a pitch movement defined by Ry.cos (4.f.2.π.t), a yaw movement defined by Rz. sin (6.f.2.π.t), a translational movement along X defined by Tx sin (5.f.2.π.t), a translational movement along Y defined by Ty.cos (5.f.2.π.t), and a translational movement along Z defined by Tz.cos (6.f.2.π.t).

The periodic movement is applied to object 10 at several cycle frequencies in order to cover a frequency range of interest. This frequency range may be defined according to the knowledge that one has of the frequency area where one is likely to find the resonance or the operational domain of object 10.

At each cycle frequency, the periodic movement is carried out in full, and may be repeated as many times as necessary in order to uncover the possible resonance modes at each frequency. The different cycle frequencies used, as well as the frequency increment between two cycle frequencies, is preferentially adapted to the dynamic behavior that one wishes to demonstrate. Thus, according to one embodiment, the frequency increment between two cycle frequencies is at an expected frequency width of the resonance modes. About ten frequencies may initially be placed between the high frequency and the low frequency of the predefined frequency range. The frequency increment may then be narrowed to around the identified resonance frequencies. When periodic movements are carried out at different cycle frequencies, they may be carried out in an ordered manner, for example ordered by increasing cycle frequency starting from a lower limit of the predefined frequency range.

Activation of drive device 14 which makes it possible to impart periodic movement to object 10, happens at the same time as a recording of data collected from one or more sensors C. Sensors C make it possible to collect the variation of at least one variable representative of the dynamic behavior of the object, referred to as “dynamic variable,” such as for example a resonance condition, referred to as “resonance variable.” The resonance variable is a measurement that makes it possible to measure, directly or indirectly, a relative displacement inside the object (e.g. force, displacement, acceleration, pressure, etc.).

Sensor(s) C is or are disposed on at least one of the platform 12 and object 10. The type of sensors C and the variables that they measure are chosen by the user according to the characteristics of parts likely to have dynamic behavior (e.g., resonance) (i.e., the non-rigid parts) that the user wants to identify. The sensor(s) C may be, for example, force sensors making it possible to measure at each time the forces undergone by object 10 or a part of object 10, accelerometers on the parts of object 10 prone to resonance, pressure sensors or strain gauges on certain points of interest (for example, the walls of a reservoir, if the object is a reservoir that is at least partially filled with liquid). The measurements of sensors C are recorded at various times during each of the periodic movements. According to one embodiment, the collection of data from sensors C is carried out at a frequency higher than at least 4 times the highest of the elementary frequencies (among the elementary frequencies of elementary movements composing the periodic movement) and preferably higher than 10 times.

When drive device 14 is a hexapod positioning head, it may be advantageous to equip at least 3 of the 6, or even each, of support(s) 116 with force sensors. In fact, a one-to-one relationship then exists between the axial forces along the six supports 116 and the torque of the forces applied to plate 114 on which object 10 is fixed.

Method 50 thus starts in step 52 by the activation of drive device 14 so as to give to object 10 a predefined periodic movement at a cycle frequency that is within a predefined frequency range such as described above. During activation, the variations of one or more variables representative of a dynamic behavior of object 10 (for example, representative of resonance conditions) are collected by means of the sensors. Activation of drive device 14 and recording of the dynamic behavior of the object are carried out at various cycle frequencies at each time during at least one period of the periodic movement. The various cycle frequencies are within a predefined frequency range.

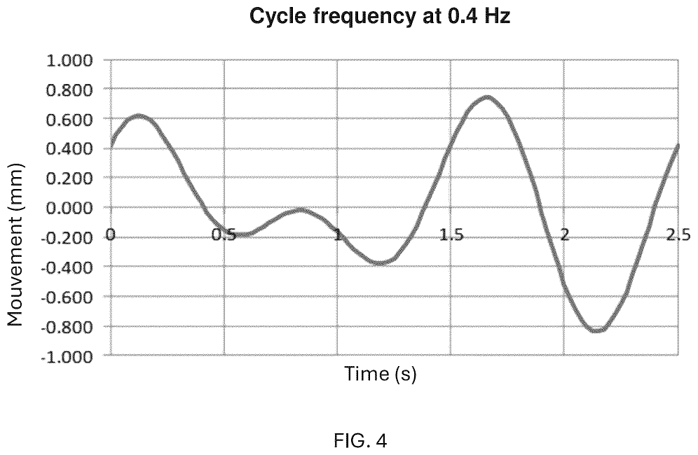

FIG. 4 shows an example of a variation over time of a dynamic variable of the object (displacement), in this case a variable likely to cause the appearance of resonance frequencies of the object, for a periodic movement at a cycle frequency of 0.4 Hz.

Thus at step 52, this variation over time is obtained for various cycle frequencies.

At step 54, a calculating unit (which may be the central processing unit UC), that has access to the data from sensors C, calculates the Fourier transform of each sensor on the elementary frequencies of each cycle. Each Fourier transform corresponding to an elementary frequency is referred to as an “elementary component.” The calculating unit determines a dynamic behavior of the object by means of the analysis of variations in elementary components as a function of the elementary frequencies.

The calculating unit calculates, for each of the cycle frequencies at which object 10 has undergone periodic movement, the components of a Fourier transform of the variation of the resonance variable(s) for each elementary frequency. The components obtained are referred to as “elementary components.” They include an intensity elementary component and a phase elementary component.

According to one embodiment, determining the dynamic behavior of the object comprises determining whether the object is, at least in part, non-rigid. Mathematically this can result in a comparison between the variation in the elementary components of forces applied to the object and a square of the cycle frequency (or of each elementary frequency). Thus, if it is observed that the variation in the elementary components of forces is not a linear function of the square of the cycle frequency, then it is concluded that the object is, at least in part, non-rigid. This determination may be of interest in cases where it is not certain that the object is non-rigid. For example, an object may comprise certain non-rigid parts such as suspensions, cables or reservoirs of liquid. If these parts have a very low mass compared to the total mass of the object, their impact on the overall forces applied to the object may be negligible. In this case, the elementary components of the overall forces have a behavior that is very close to a linear law as a function of the square of the cycle frequency. Nevertheless, specific sensors placed on the non-rigid parts may identify a resonant behavior.

According to one embodiment, the determination of the dynamic behavior of object 10 comprises the determination of resonance frequencies and, optionally, the resonance modes of object 10 from among the frequencies in the range of frequencies of the periodic movement to which the object was subjected. These determinations can be made whether or not the determination that the object is, at least in part, non-rigid has previously been made.

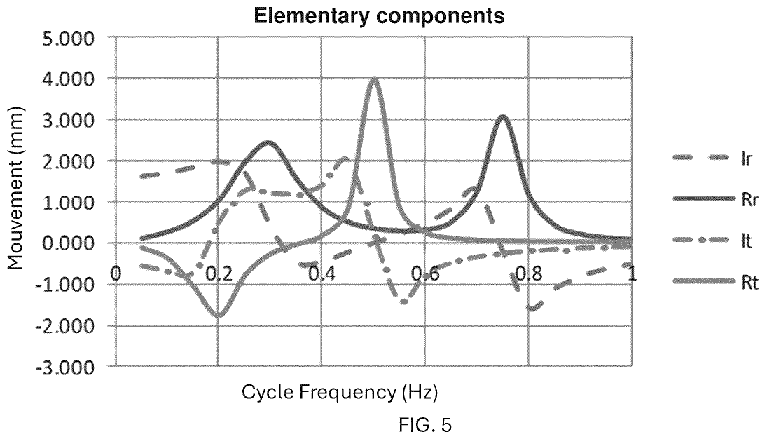

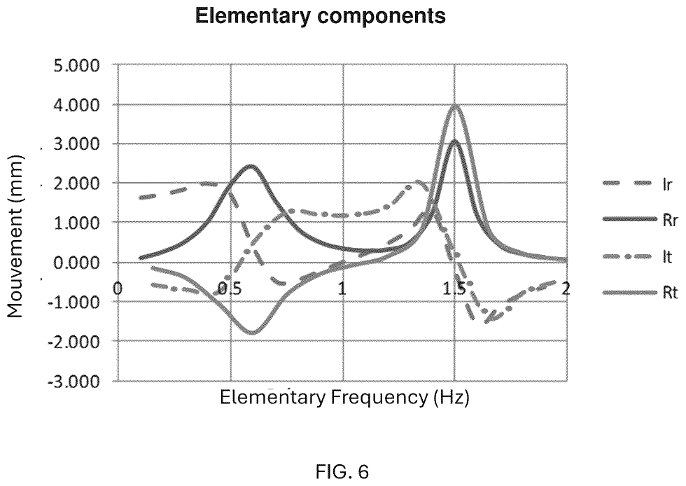

FIG. 5 shows an example of elementary components obtained as a function of the cycle frequency. In this example, the periodic movement is as illustrated in FIG. 3, i.e., it is a combination of two elementary movements: a roll movement r defined by r=a.sin (2.u), and a pitch movement t defined by t=a.sin (3.u), where u=2.π.f.t, f being the cycle frequency, at the angular amplitude, and t being the time. The period of the periodic movement is T=1/f. The angular amplitude is, for example, a=100 mrd. The elementary components obtained are thus, in this example, roll intensity elementary component (Ir), roll phase elementary component (Rr), pitch intensity elementary component (It), and pitch phase elementary component (Rt). FIG. 5 shows the progression of elementary components Rr, Ir, Rt, It as a function of the cycle frequency, and FIG. 6 shows the progression of the same elementary components, but as a function of the elementary frequency corresponding to each elementary component.

Obtaining the variation in elementary components as a function of elementary frequency will make it possible to identify one or more resonance frequencies of object 10. Thus at step 56, at least one resonance frequency is identified for each elementary movement, based on variations in accordance with the elementary frequencies of the elementary components of each elementary movement. For this, according to one embodiment, an extremum of the intensity elementary component is identified for each elementary movement. In the example from FIG. 6, there are two extremums for the roll and two extremums for the pitch (for each one at the elementary frequency 0.6 Hz and 1.5 Hz). These extremums make it possible to define the resonance frequencies. In fact, when a parameter is sensitive to a resonance mode of an object or a part of this object, the amplitude of the variation of this parameter varies as a function of the frequency of the periodic movement applied to it, and reaches a maximum at the resonance frequency.

In contrast, for a rigid object, variations in the elementary components as a function of the frequency (cycle or elementary) depend only on the weight and the inertial forces. Weight is independent of the cycle frequency and inertial forces are proportional to the square of the cycle frequency. As a consequence, the elementary components do not present any extremum as a function of this frequency for a rigid object. The appearance of an extremum of an elementary component as a function of frequency thus essentially reflects the existence of a resonance mode of at least one part of the object. In certain configurations, it is possible to isolate this part of the object. For example, in the case of a reservoir, it is possible to measure the elementary components with the reservoir empty or completely filled such that there is no movement of liquid (measured by applying the same periodic movement at the same frequencies but on the empty reservoir). In this case, it is advantageous to remove the elementary components measured with the empty reservoir, for example, from those measured with the reservoir partially filled. This method makes it possible to isolate the elementary components connected only to the liquid during movement and thus to identify more clearly its resonance modes.

According to one embodiment, these extremums are defined as representative of a resonance frequency if the corresponding phase elementary component has a rapid variation. In fact, another characteristic of a resonance mode is that the phase of the response of sensor C in relation to the stress varies more rapidly near the resonance frequency than around the other frequencies. Rapid is to be understood as in comparison to the rest of the variation. For example, for the example from FIG. 6, it is noted that at the elementary frequencies of 0.6 Hz and 1.5 Hz (corresponding to the intensity elementary component extremums), the roll phase elementary component has a rapid decrease. As a consequence, frequencies of 0.6 Hz and 1.5 Hz are resonance frequencies for the roll and pitch movements. Furthermore, it is noted that at the elementary frequency of 0.6 Hz, the pitch phase elementary component has a rapid increase, and at the elementary frequency of 1.5 Hz, the pitch phase elementary component has a rapid decrease.

Thus, according to one embodiment, the method additionally comprises the identification of a resonance mode of the resonance variable. A resonance mode is associated with each of the resonance frequencies identified for each elementary movement. Therefore, there may be several modes if there are several identified frequencies. Each resonance mode is characterized by the identified resonance frequency, an amplitude of the intensity elementary component at the identified resonance frequency, and a direction associated with the elementary movement for which the resonance frequency was identified.

According to an embodiment, if one of the resonance frequencies identified for each of the elementary movements is identical for several elementary movements, then the resonance mode is characterized by the combination of these elementary movements (for example, roll and pitch).

1. A method of identifying the dynamic behavior of a non-rigid object, the object being firmly fixed to a platform that can be set in motion by a drive device, the method comprising:
Activating the drive device so as to impart to the object a predefined periodic movement at a frequency referred to as “cycle frequency,” the periodic movement being a combination of at least two geometrically-independent periodic movements, the at least two elementary movements each having a frequency referred to as “elementary frequency,” which is an integer multiple of the cycle frequency, at most two of the at least two elementary movements being of the same elementary frequency; if the periodic movement comprises two elementary movements of a same elementary frequency then they are of different phases, preferentially in phase quadrature, the activation being done during at least one period of the periodic movement;
Recording, during the activation, the variation of at least one variable representative of a dynamic behavior, referred to as “dynamic variable,” collected by at least one sensor disposed on at least one of the platform and the object;
Repeating the activation of the drive device and recording of the variation of the at least one dynamic variable at various cycle frequencies at each time during at least one period of the periodic movement, the various cycle frequencies being within a predefined frequency range;
Calculating, by a calculating unit, for each of the cycle frequencies within the predefined frequency range, the components of a Fourier transform of the variation of the at least one dynamic variable for each elementary frequency, the components, referred to as “elementary components,” including an intensity elementary component and a phase elementary component; and
Determining, as a function of the variation in the elementary components, a dynamic behavior of the object.

2. The method of claim 1, wherein the at least two elementary movements have two different elementary frequencies, preferentially in ratios of 2 and 3 or 3 and 4 in relation to the cycle frequency.

3. The method of claim 1, wherein the at least two elementary movements have three different elementary frequencies, preferentially in ratios of 4, 5 and 6 in relation to the cycle frequency.

4. The method of claim 1, wherein determining the dynamic behavior of the object comprises observing that the variation in elementary components is not a linear function of the square of the cycle frequency.

5. The method of claim 1, wherein the at least one variable representative of a dynamic behavior is representative of a condition of resonance of the object, the variable being referred to as “resonance variable,” and
determining the dynamic behavior of the object comprises identifying at least one resonance frequency for each of the at least two elementary movements based on variations in accordance with the elementary frequencies of the elementary components of each of the at least two elementary movements.

6. The method of claim 5, wherein, in order to identify at least one resonance frequency for each of the at least two elementary movements, the method includes identifying an extremum of the intensity elementary component for each of the at least two elementary movements.

7. The method of claim 5, furthermore comprising determining an amplitude of the at least one resonance variable for the at least one resonance frequency, the determination being made based on variations in the at least one resonance variable in accordance with the elementary frequencies of the elementary components for each of the at least two elementary movements.

8. The method of claim 7, wherein the amplitude of the at least one resonance variable is the amplitude of the extremum of the intensity elementary component of the at least one resonance variable at the at least one identified resonance frequency.

9. The method of claim 5, furthermore comprising identifying, for each of the identified resonance frequencies, of a resonance mode of the at least one resonance variable, the resonance mode furthermore being characterized by an amplitude of the intensity elementary component at the resonance frequency under consideration, and a direction associated with the elementary movement for the resonance frequency under consideration.

10. The method of claim 9, wherein, if one of the identified resonance frequencies for each of the at least two elementary movements is identical for several elementary movements, then the resonance mode is characterized by the combination of these elementary movements.

11. The method of claim 1, wherein the object is a reservoir containing a liquid, and the determining of the dynamic behavior comprises a step of measuring the dynamic variables with the empty reservoir, and determining, by subtracting the elementary components, only the effects of the liquid.
